(19) United States
(12) Patent Application Publication
(10) Pub. No.: US 2026/0066422 A1
(43) Pub. Date: Mar. 5, 2026

(54) BATTERY PACK

(71) Applicant: TOYOTA JIDOSHA KABUSHIKI KAISHA, Toyota-shi (JP)

(72) Inventor: Nobuyasu NISHIKI, Toyokawa-shi (JP)

(73) Assignee: TOYOTA JIDOSHA KABUSHIKI KAISHA, Toyota-shi (JP)

(21) Appl. No.: 19/313,178

(22) Filed: Aug. 28, 2025

(30) Foreign Application Priority Data
Sep. 5, 2024 (JP) 2024-153185

(51) Int. Cl. H01M 50/24; H01M 50/224; H01M 50/242; H01M 50/26

(52) U.S. Cl. CPC H01M 50/24; H01M 50/224; H01M 50/242; H01M 50/26

(57) ABSTRACT

To provide a battery pack configured to control water ingress to the battery pack. A battery pack including: an upper case including an upper case main body and an upper case flange provided at an end part of the upper case main body; and a lower case including a lower case main body and a lower case flange provided at an end part of the lower case main body the lower case being arranged below the upper case, in which a bending load at which the upper case flange starts to deform is weaker than a peel strength at which an adhesive inserted into a gap between the upper case flange and the lower case flange starts to peel off in fixing the upper case flange to the lower case flange.

### CROSS REFERENCE TO RELATED APPLICATIONS

This application is based upon and claims the benefit of priority from Japanese patent application No. 2024-153185, filed on Sep. 5, 2024, the disclosure of which is incorporated herein in its entirety by reference.

### BACKGROUND

The present disclosure relates to a battery pack.

In recent years, a battery pack, in which a battery module integrating a plurality of battery cells is accommodated in a case, has been used

This case is formed by fastening a lower case to an upper case.

Patent Literature 1 describes that a flange of an upper case has a protruding part provided thereto which protrudes in a lower case side, and a sealing material made of urethane resin adhesive is filled in a gap between the flange of the upper case and the flange of the lower case.

At this time, the sealing material is filled inside the battery case rather than the protruding part of the upper case, and is adhered to the flange of the upper case and the flange of the lower case. After that, the gap between the flanges of the upper case and the lower case is sealed by curing a sealing material with the sealing material adhered to the respective flanges.
[Patent Literature 1] Japanese Unexamined Patent Application Publication No. 2023-046615

### SUMMARY

In the battery case disclosed in Patent Literature 1, the flange of the upper case and the flange of the lower case have high rigidity, i.e., the respective flanges are configured without taking into account the possibility of deformation thereof. Therefore, in the event of collision or the like causing an external force to act on the battery case, adhesive may come off the gap provided between the flanges, causing damage to the adhesive part. In this case, in the battery pack under an environment in which there is moisture outside the battery pack, there is a risk of water ingress to the battery pack in which battery modules and devices are installed.

The present disclosure provides a battery pack configured to control water ingress to the battery pack.

According to the present disclosure, a pack includes: an upper case including an upper case main body and an upper case flange provided at an end part of the upper case main body; a lower case including a lower case main body and a lower case flange provided at an end part of the lower case main body, the lower case being arranged below the upper case, in which a bending load at which a bending load at which the upper case flange starts to deform is weaker than a peel strength at which an adhesive inserted into a gap between the upper case flange and the lower case flange starts to peel off in fixing the upper case flange to the lower case flange. Thus, in the case in which an external force acts on the battery pack, it is possible to prevent deformation of the flanges themselves without the adhesive coming off, and damage to the adhesive part can be controlled.

According to the present disclosure, it is possible to provide a battery pack configured to control water ingress to the battery pack.

The above and other objects, features and advantages of the present disclosure will become more fully understood from the detailed description given hereinbelow and the accompanying drawings.

### BRIEF DESCRIPTION OF DRAWINGS

FIG. 1 is a side view showing a configuration example of a battery pack according to a first embodiment;

FIG. 2A is an enlarged side view showing a state in which an external force acts on a flange part according to the first embodiment;

FIG. 2B is an enlarged side view showing a state in which an external force acts on a flange part according to the first embodiment;

FIG. 3A is a side view showing a state in which an upper case flange has a bent part according to the first embodiment;

FIG. 3B is a side view showing a state in which an upper case flange has a bent part according to the first embodiment;

FIG. 4 is a side view of a battery pack with an EA material and a reinforcement attached thereto according to the first embodiment;

FIG. 5 is a perspective view of the reinforcement according to the first embodiment; and

FIG. 6 is a side view of a battery pack in which an external force acts on the EA material according to the first embodiment.

### DESCRIPTION OF EMBODIMENTS

### First Embodiment

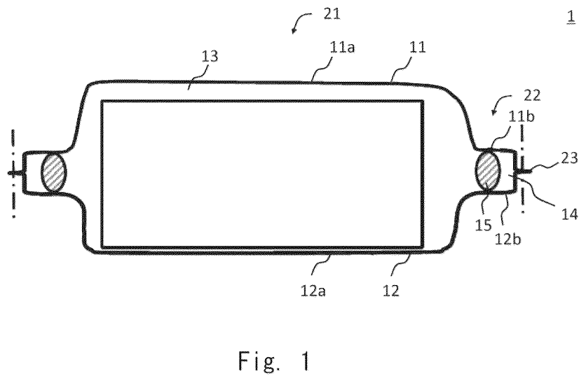

A battery pack according to this embodiment will be described below with reference to the drawings. FIG. 1 is a schematic diagram showing an example of a configuration of a battery pack 1.

As shown in FIG. 1, the battery pack 1 includes an upper case 11 and a lower case 12. As shown in FIG. 1, the description will be made assuming that the battery pack 1 is disposed with the longitudinal side thereof in the X-direction, and that an upper case flange 11b and a lower case flange 12b, which will be described later, are respectively provided at an end part of the battery pack 1 in the X-direction. Further, the description will be made assuming that the upper case 11 is arranged on the upper side in the Z-direction and the lower case 12 is arranged on the lower side in the Z-direction, and that the upper case 11 and the lower case 12 are joined. The X, Y, and Z-directions are orthogonal to each other.

The upper case 11 has an upper case main body 11a and an upper case flange 11b. The upper case flange 11b is formed at both ends of the upper case main body 11a in the X-direction.

The lower case 12 has a lower case main body 12a and a lower case flange 12b. The lower case flange 12b is formed at both ends of the lower case main body 12a in the X-direction.

The upper case main body 11a and the lower case main body 12a are disposed in an opposing arrangement in the Z-direction. In the following description, the upper case main body 11a and the lower case main body 12a are collectively referred to as a main body 21.

The upper case flange 11b and the lower case flange 12b are disposed in an opposing arrangement in the Z-direction. In the following description, the upper case flange 11b and the lower case flange 12b are collectively referred to as a flange part 22, and the flange part 22 is provided at both ends of the main body 21 in the X-direction. Also, the part of the battery pack in the X-direction to which the vicinity of the tip of the upper case flange 11b and the vicinity of tip of the lower case flange 12b are fastened is referred to as a fastening part 23.

In the following description, the space formed between the upper case main body 11a and the lower case main body 12a is referred to as a storage unit 13, and the space formed between the upper case flange 11b and the lower case flange 12b is referred to as a gap 14. Note that the upper case flange 11b and the lower case flange 12b are joined and sealed by an adhesive 15 in the gap 14.

Note that the storage unit 13 and the gap 14 are integrally-formed spaces. Therefore, the battery pack 1 has such a configuration that displacement can be prevented by fastening the upper case flange 11b to the lower case flange 12b with the fastening part 23 in the X-direction end part of the flange part 22, and can seal the storage unit 13 by blocking the gap 14 with the adhesive 15.

The main body 21 has a sufficient length in X, Y, and Z-directions. Therefore, the storage unit 13, which is a space in the main body 21, has sufficient length in X, Y, and Z-directions, and can store battery modules, relays, and other devices. Here, the main body 21 has a substantially rectangular parallelepiped shape extending in the X-direction, and a detailed description of an example of the shape thereof will be described later.

The flange part 22 is shorter than the main body 21 in each of the X, Y, and Z-directions. Furthermore, the flange part 22 is longer in the X-direction than in the Y and Z-directions.

Here, the flexural rigidity of the upper case flange 11b is assumed to be weaker than the peel strength of the adhesive 15. In other words, the bending load at which the upper case flange 11b starts to deform is assumed to be weaker than the peel strength at which the adhesive 15 starts peel off. Specifically, in the flange part 22, the thickness of the plate forming the upper case flange 11b is sufficiently reduced to reduce the rigidity. Thus, in the flange part 22, the following holds: peel load due to adhesion of the adhesive 15>bending load of the upper case 11.

In this state, when an external force acts on the flange part 22, the upper case flange 11b deforms following the deformation of the lower case flange 12b. Therefore, in the flange part 22, since it is possible to perform control of an excessive force from acting on the adhesive 15 filled in the gap 14, the seal peeling of the adhesive 15 can be avoided. The reduction in the rigidity of the upper case 11, the adhesion of the adhesive 15, and the following of the deformation will be described in detail later.

Since the lower case 12 is configured to support the lower part of the battery modules and equipment stored in the storage unit 13, it is necessary to have high strength and high rigidity. On the other hand, since the upper case 11 is configured to cover the battery modules and equipment stored in the storage unit 13, rigidity thereof can be reduced. Therefore, in the upper case 11, the rigidity of both the upper case main body 11a and the upper case flange 11b can be reduced.

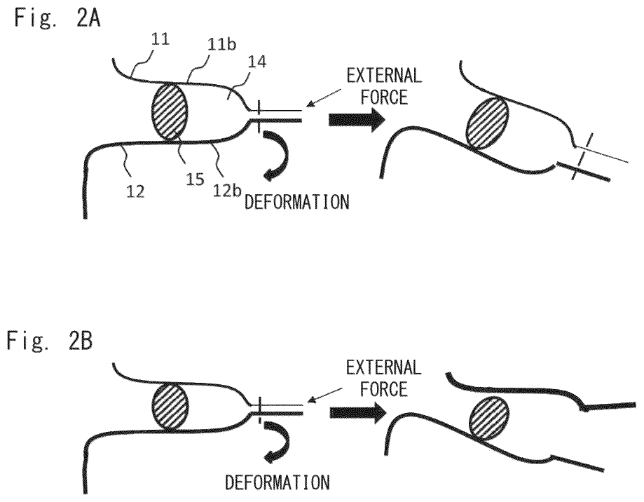

Next, a concrete state of the flange part of a case in which an external force acts on the flange part 22 will be described. FIGS. 2A and 2B are enlarged views of the flange part 22 showing a state in which an external force of several tens of N has acted on the flange part 22 causing the gap 14 formed therein to deform. FIG. 2A shows a state in which the rigidity of the battery pack 1 and the upper case 11 is reduced, and FIG. 2B shows an example of a state in which the rigidity of the related battery pack and the upper case 11 is high. In both cases, the adhesive 15 is inserted into the gap 14 in the flange part 22, and the adhesive 15 is bonded to the upper case flange 11b and the lower case flange 12b.

Here, it is assumed that a large load of several tens of kN is applied to the flange part 22 shown in FIGS. 2A and 2B due to a collision or the like. Here, an external force acts from the upper case flange 11b side onto the lower case flange 12b side, that is, downward.

As shown in FIG. 2B, in the case where the upper case flange 11b has a higher flexural rigidity than the peel strength of the adhesive 15, the gap 14 spreads because the state of deformation of the upper case flange 11b and that of the lower case flange 12b do not match. Therefore, the adhesive 15 is typically peeled off from one of the upper case flange 11b and the lower case flange 12b.

On the other hand, as shown in FIG. 2A, the upper case flange 11b has a flexural rigidity lower than the peel strength of the adhesive 15. Therefore, the upper case flange 11b easily follows the deformation of the lower case flange 12b. Therefore, the adhesive 15 can remain adhered to the upper case flange 11b and the lower case flange 12b.

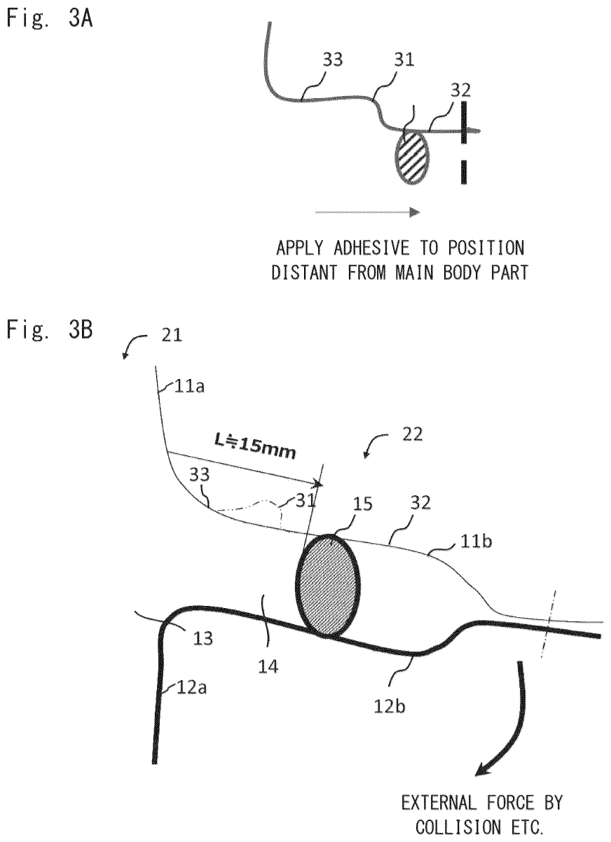

Next, with reference to FIGS. 3A and 3B, an example in which the upper case flange 11b has a bent part 31 will be described.

As shown in FIG. 3A, the upper case flange 11b includes the bent part 31, a first flange part 32, and a second flange part 33. Here, the bent part 31 is arranged between the first flange part 32 and the second flange part 33.

Specifically, the first flange part 32 is provided at an end part side of the upper case flange 11b in the X-direction and is arranged so that the distance between the first flange part 32 and the lower case flange 12b is short. On the other hand, the second flange part 33 is provided at a position closer to the upper case main body 11a side in the X-direction as compared with the first flange part 32. Here, the second flange part 33 is arranged so that the distance between the second flange part 33 and the lower case flange 12b is longer than the distance between the first flange part 32 and the lower case flange 12b. Therefore, in the upper case flange 11b, the first flange part 32 and the second flange part 33 are separated due to the bent part 31.

Thus, the bent part 31 where R is increased can be formed in advance in the upper case flange 11b. This makes it easier to deform the upper case flange 11b when subjected to an external force.

Furthermore, the place where the adhesive 15 is injected is the gap 14 at the position of the first flange part 32. That is, in the flange part 22, the place where the adhesive 15 is inserted in the gap 14 and sealed is located outside of the bent part 31 in the X-direction. As a result, in the battery pack 1, in the case where an external force acts on the flange part 22, the moment length up to the adhesive 15 with reference to the main body 21 becomes longer, and facilitating deformation.

FIG. 3B is an enlarged view showing, as an example, a state in which an external force acts on the flange part 22 in which the upper case flange 11b has the bent part 31. In FIG. 3B, an example of a state in which the bent part 31 is not provided is shown by a solid line, and an example of a state in which the upper case flange 11b has the bent part 31 is shown by a dash-dotted line.

The upper case 11 and the lower case 12 are each formed of a steel plate. As an example of the dimensions, the thickness of a steel plate used for the upper case 11 is about t=0.6 mm, and the thickness of a steel plate used for the lower case 12 is about t=1.0 mm. Here, the thickness of the upper case 11 is definitely smaller than that of the lower case 12.

The adhesive 15 is arranged on the first flange part 32 in the gap 14. As an example, in the case where the length of the main body 21 in the X-direction is about 200 mm, the adhesive 15 is applied on the main body 21 adjacent thereto at a position where the distance from the end part in the X-direction is about 15 mm.

Here, the adhesive 15 can be made of urethane, and a peel load in this case is about 2.0 N/mm. Here, a deform load F of the upper case 11 is calculated as F=0.6 N/mm by solving the equation 150=F (N)×15/(1/6×1×0.6\hat{ }2), since the yield stress is assumed to be 150 MPa.

That is, the load required to bend the upper case is 0.6 N/mm for the upper case bending load, and the load required to peel the adhesive 15 is 2.0 N/mm for the peel load, the bending load being higher than the peel load. As an example, the value of the peel load is at least twice as high as that of the upper case bending load. Therefore, even when a load of several kN or more is applied to the flange part 22 by an external force caused by collision or the like, the adhesive 15 is not peeled off, and the upper case 11 follows deformation of the lower case 12.

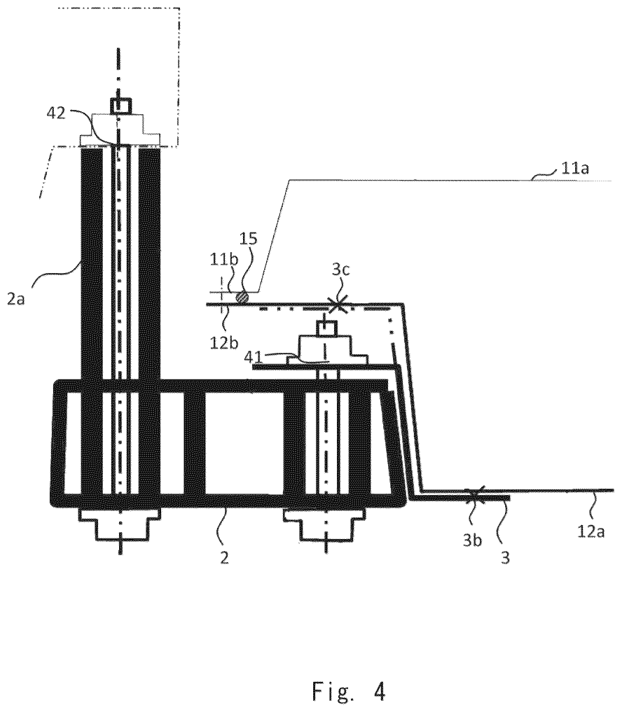

Referring to FIGS. 4 to 6, an example of a state in which an external force acts on the battery pack 1 will be described. FIG. 4 shows a state in which an EA (Energy Absorption) material 2 made of extruded aluminum or the like is attached to the battery pack 1. The battery pack 1 and the EA material 2 are connected via a connecting reinforcement 3. Here, the battery pack 1 is used for a vehicle, and a rocker inner of a vehicle body is joined to the EA material 2.

As shown in FIG. 4, in the battery pack 1, the lower case flange 12b is longer than the upper case flange 11b. The upper case flange 11b and the lower case flange 12b are joined by the fastening part 23, and the inside of the gap 14 formed on the inner side with respect to the fastening part 23 is sealed by the adhesive 15.

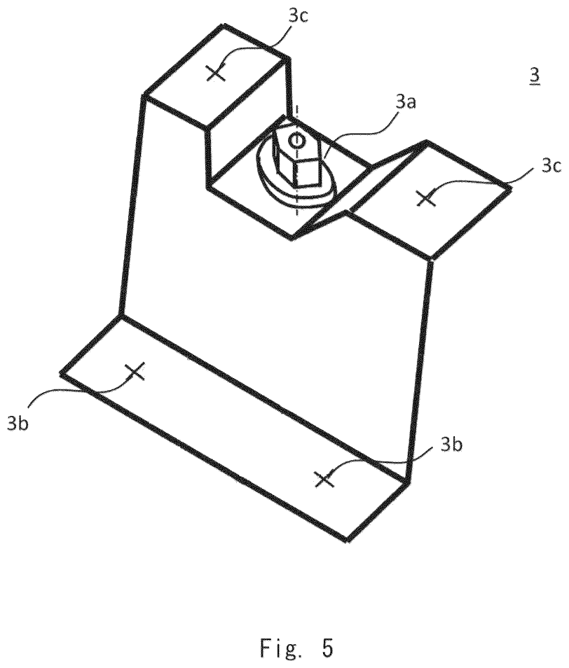

Here, FIG. 5 is an example showing the external appearance of the reinforcement 3. The upper part of the reinforcement 3 has a recessed part 3a which is partially recessed downward, and a fastening part such as nuts can be set thereto. Further, the reinforcement 3 has a plurality of spot welding points 3b and a plurality of spot welding points 3c set at the lower end part and the upper end part thereof, respectively, in the Z-direction.

FIG. 4 shows an example in which a spot welding point 3b of the reinforcement 3 is joined to the lower part of the lower case main body 12a, and a spot welding point 3c is joined to the lower part of the lower case flange 12b.

The joining of the EA material 2 and the reinforcement 3 will now be described. The EA material 2 extends in the X-direction and is joined to the reinforcement 3 at a position close to the main body 21. In addition, the EA material 2 is joined by a fastening part, such as bolts and nuts, which is set in the recessed part 3a of the reinforcement 3. Typically, the joining point of the EA material 2 and the reinforcement 3 is at a position below the lower case flange 12b. The fastening part of the EA material 2 and the reinforcement 3 is referred to as the reinforcement fastening part 41.

That is, a part of the reinforcement 3 is arranged so as to be sandwiched between the EA material 2 and the lower case flange 12b, and is fastened using bolts which penetrate the EA material 2 and the reinforcement 3.

Next, the joining of the EA material 2 and a rocker inner 4 will be described. The EA material 2 and the rocker inner 4 are joined in a state in which the rocker inner 4 is arranged above the EA material 2 at the further tip end side than the flange part 22 in the X-direction.

As an example, an EA collar 2a is formed at the tip end part of the EA material 2 in the X-direction, and a long bolt penetrates in the Z-direction and is fastened to the lower part of the rocker inner 4 arranged above the EA collar 2a. Thus, the EA material 2 and the rocker inner 4 are joined by bolts and nuts. The fastening part of the EA material 2 and the rocker inner 4 is referred to as a rocker inner fastening part 42.

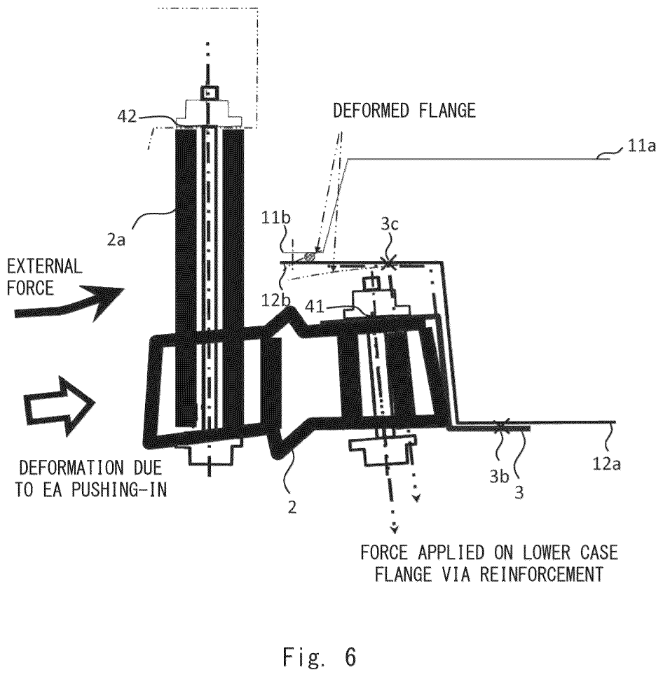

Next, FIG. 6 shows an example of a state in which an external force by collision or the like is added to the EA material 2. Here, there is a gap in height between the rocker inner fastening part 42 and the EA material 2 in the Z-direction. Therefore, as indicated by the arrow in FIG. 6, in the case where an external force acts from the tip end side in the X-direction, the EA material 2 is crushed while rotating counterclockwise.

Due to this counterclockwise rotation of the EA material 2, a downward force acts on the reinforcement fastening part 41 where the EA material 2 and the reinforcement 3 are joined. At this time, the downward force acts on the spot welding points 3b and 3c where the reinforcement 3 and the lower case 12 are joined. At this time, spot welding point 3c where the reinforcement 3 and the lower case flange 12b are joined is in a state in which a larger downward force is applied compared to the spot welding point 3b where the reinforcement 3 and the lower case main body 12a are joined. In this case, the lower case flange 12b deform such that the tip end side thereof is pulled downward.

Here, the upper case flange 11b is formed of a thin steel plate and is therefore easily deformed. Therefore, the upper case flange 11b easily follows the downward deformation of the lower case flange 12b. Thus, the adhesive 15 can be prevented from peeling off from the upper case flange 11b and the lower case flange 12b in the gap 14.

The upper case flange 11b and the lower case flange 12b can have the end part to which the fastening part 23 is provided bent downward in advance.

Thus, the distance between the tip end part of the flange part 22 and the EA collar 2a can be increased. That is, in the battery pack 1, the distance by which the EA collar 2a can be operated without colliding against the flange part 22 when the EA collar 2a is operated so that it comes to a position close to the flange part 22 due to an external force, can be set long.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A battery pack comprising:
an upper case including an upper case main body and an upper case flange provided at an end part of the upper case main body; and
a lower case including a lower case main body and a lower case flange provided at an end part of the lower case main body, the lower case being arranged below the upper case,
wherein a bending load at which the upper case flange starts to deform is weaker than a peel strength at which an adhesive inserted into a gap between the upper case flange and the lower case flange starts to peel off in fixing the upper case flange to the lower case flange.

2. The battery pack according to claim 1, wherein the upper case flange includes:
a first flange part provided at an end part side of the upper case flange and arranged so that a distance between the first flange part and the lower case flange is short;
a second flange part provided at a position closer to the upper case main body side as compared with the first flange part and arranged so that a distance between the second flange part and the lower case flange is longer than the distance between the first flange pat and the lower case flange; and
a bent part formed between the first flange part and the second flange part.

3. The battery pack according to claim 2, wherein
the upper case is formed of a steel plate,
the lower case is formed of a steel plate, and
the steel plate used for the upper case is thinner than the steel plate used for the lower case.

4. The battery pack according to claim 3, wherein
the adhesive is made of urethane, and
a value of the peel load of the adhesive is at least twice as high as a value of the bending load of the upper case.

5. The battery pack according to claim 4, wherein a tip end of the upper case flange and a tip of the lower case flange are bent downward in advance.
